(19) United States
(12) Patent Application Publication
(10) Pub. No.: US 2009/0095665 A1
(43) Pub. Date: Apr. 16, 2009

(54) Anti-Drainback Valve For An Oil Filter

(75) Inventors: Dipak R. Patel, Grand Blanc, MI (US); Thomas A. Spix, Rochester Hills, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/870,469

(22) Filed: Oct. 11, 2007

(51) Int. Cl. B01D 35/14

(52) U.S. Cl. 210/130

(57) ABSTRACT

An anti-drainback apparatus for an oil filter assembly includes an anti-drainback valve formed from an elastomeric material. The anti-drainback valve is operable to selectively restrict reverse flow through the oil filter assembly. The anti-drainback valve is generally frusta-conical in shape and includes at least one relief valve to selectively open in the presence of a predetermined pressure to allow reverse flow through the oil filter assembly. An oil filter assembly is also provided incorporating the disclosed anti-drainback valve.

### TECHNICAL FIELD

The present invention relates to an anti-drainback valve for use within an oil filter.

### BACKGROUND OF THE INVENTION

Liquid filters, such as an engine oil filter, may employ an anti-drainback valve which operates to prevent oil from draining from the passages within the engine during shut-down thereby providing a measure of protection against noise emitted by components, such as the valvetrain components, during re-start of the engine. Newly manufactured engines are generally provided with oil through one of the passages defined by the engine (i.e. a fill passage) in order to lubricate interfaces and provide oil to the engine's oil pump for oil pump priming prior to starting the engine. The fill passage tends to be located downstream from the oil filter, while the oil pump tends to be located upstream from the oil filter and, as such, the anti-drainback valve within the oil filter tends to restrict oil flow to the oil pump thereby increasing the time required to prime the oil pump. Consequently, a filter may be installed without an anti-drainback valve to allow an adequate amount of oil to reach the oil pump to enhance oil pump priming during the filling operation.

### SUMMARY OF THE INVENTION

An anti-drainback apparatus for an oil filter assembly is provided. The anti-drainback apparatus includes an anti-drainback valve formed from an elastomeric material and operable to selectively restrict reverse flow through the oil filter assembly. The anti-drainback valve is generally frustoconical in shape and includes at least one relief valve to selectively open in the presence of a predetermined pressure to allow reverse flow through the oil filter assembly.

An oil filter assembly for an engine is also provided. The engine defines first and second oil passages in communication with the oil filter assembly. The oil filter assembly includes an anti-drainback valve disposed within the oil filter assembly and operable to substantially restrict the flow of oil from the first oil passage when the pressure differential between the first oil passage and second oil passage is below a predetermined value. The anti-drainback valve includes at least one relief valve operable to selectively open to allow the flow of oil from the first oil passage when the pressure differential between the first oil passage and second oil passage is greater than or equal to the predetermined value.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic sectional view of an oil filter assembly incorporating an anti-drainback valve; and

FIG. 2 is a schematic bottom view of the anti-drainback valve of FIG. 1 illustrating a plurality relief valves incorporated within the anti-drainback valve.

### DESCRIPTION OF THE PREFERRED EMBODIMENTS

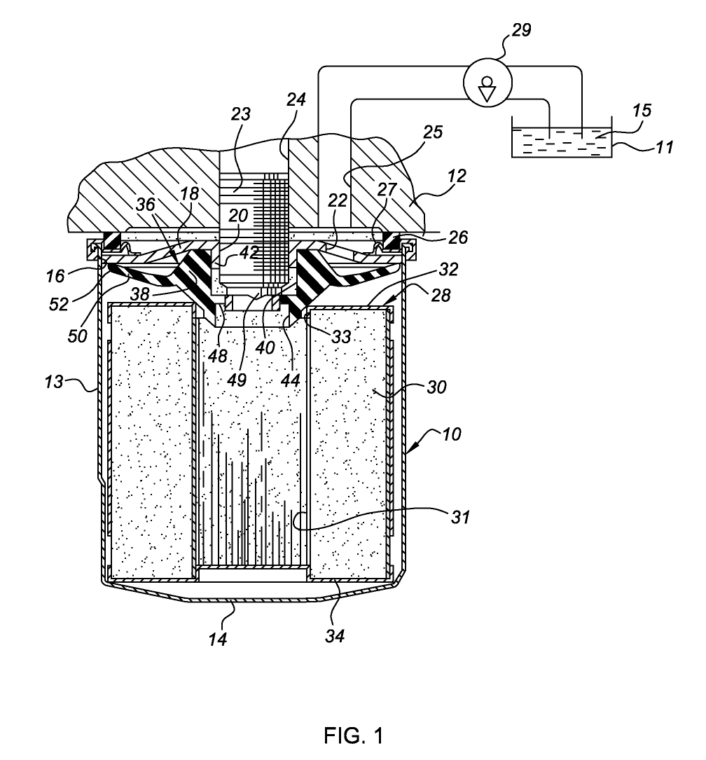

Referring to the drawings wherein like reference numbers correspond to like or similar components throughout the several figures, FIG. 1 shows an oil filter 10 for filtering the lubricating oil used in an engine 12. The engine 12 includes a reservoir 11, such as an oil pan, configured to contain a predetermined amount of oil 15. The oil filter 10 comprises a cylindrical canister 13 having a closed end 14 and an open end 16. The open end 16 is partially closed by a closure plate 18 having a central fluid outlet 20 and a plurality of fluid inlets 22, one of which is shown in FIG. 1, that are radially arranged around the outlet 20. The outlet 20 is threaded to engage a pipe 23 extending from an oil passage 24 defined by the engine 12, while the inlets 22 are open to an oil passage such as a main oil gallery 25 defined by the engine 12 and disposed radially inward from a generally circular gasket 26. The gasket 26 is mounted on a plate 27 whose outer periphery is rolled together with the open end 16 of the canister 13 to be thereby secured to the canister 13 and also retain the closure plate 18 against outward movement. A positive displacement oil pump 29 is provided in communication with the main oil gallery 25 and is operable to communicate oil 15, under pressure, from the reservoir 11 to the main oil gallery 25 for subsequent introduction to the oil filter 10.

A cylindrical filter cartridge 28 is positioned in the canister 13 and includes a suitable filtering element 30 of suitable filter media, such as a pleated paper type media. The outer side of the filtering element 30 is spaced radially inward from the canister's cylindrical wall so that oil entering through the inlets 22 may flow to the outside of the filter cartridge 28 and then radially inwardly through the filtering element 30 to a hollow axially extending center portion 31, defined by the filter cartridge 28, and thence to the return pipe 23 where it is communicated to the main oil gallery 25. The filter cartridge 28 further includes end cover plates 32 and 34 which fit over and are sealingly secured to the opposite ends of the filtering element 30 to provide support therefor as well as provision for holding the filter cartridge 28 in position within the canister 13. The end cover 32 has a central opening 33 through which filtered oil 15 passes to the outlet 20 while the other end cover 34 has no openings therethrough and is engageable with the canister's closed end 14. A bypass valve (not shown), such as a spring loaded poppet valve, may be provided within the end cover 34 to allow oil 15 to bypass the filtering element 30 should the filtering element 30 become overly restrictive, such as by increased fluid viscosity and/or contaminate accumulation.

To prevent oil 15 from draining through the inlets 22 caused by insufficient pressure within the main oil gallery 25 due to, for example, discontinuance of the operation of the oil pump 29, there is provided an anti-drainback valve 36 formed from an elastomeric material, such as rubber, which is located between the end cover 32 of the filter cartridge 28 and the closure plate 18. In such an arrangement, one end of the filter cartridge 28 is held against the canister's closed end 14 and the anti-drainback valve 36 is sealingly engaged between the end cover 32 and the closure plate 18.

The anti-drainback valve 36 has an annular body 38 arrangeable between the closure plate 18 and the filter cartridge's end cover 32. The body 38 has a central opening 40 through which the oil 15 can pass to the outlet 20. The closure plate 18 is provided with an inwardly extending annular flange or collar 42 about the outlet 20 which fits in the opening 40 to thus coaxially locate the anti-drainback valve 36 with the closure plate 18. The body 38 additionally has an axially extending annular collar 44 in engagement with the central opening 33 of the end cover 32 of the filter cartridge 28 to provide a coaxial relationship between the anti-drainback valve 36 and the filter cartridge 28. In addition, the annular collar 44 has a radially inwardly extending annular rib 48 for sealingly engaging a smooth shoulder 49 that is formed on the end of the pipe 23.

Further describing the structure of the anti-drainback valve 36, the body 38 has a flexible, radially and axially outwardly, annular valve portion 50 of frustoconical shape with a lip 52 on its outer perimeter. The lip 52, in the absence of oil pressure within the main oil gallery 25, normally seats on the closure plate 18, radially outward of the inlets 22. Thereby preventing oil 15 contained within the oil filter 10 and hence the oil passage 24 from draining through the inlets 22 and subsequently siphoned to the sump 11. The valve portion 50 diverges axially outward and is flexible to lift off the closure plate 18 in response to pressure at the inlets 22 resulting from operation of the oil pump 29 to permit flow to the filter cartridge 28.

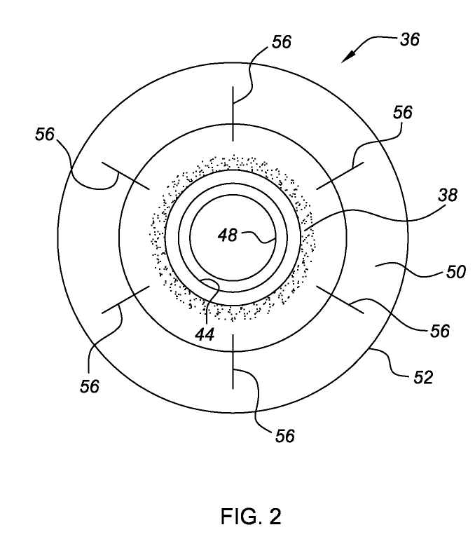

Referring to FIG. 2 there is shown a bottom view of the anti-drainback valve 36 illustrating a plurality relief valves 56 formed as slits or cuts defined therein and extending generally radially outwardly along the annular valve portion 50. The slits forming relief valves 56 may be of other shapes such as star-shapes, cross-shapes, or slits extending generally circumferentially. Those skilled in the art will recognize that any cut or slit configuration provided on the anti-drainback valve 56 that opens in response to a pressure differential may be used while remaining within the scope of that which is claimed. Additionally, the relief valves 56 may be molded features formed on the annular valve portion 50, such as one-way flapper valves. The relief valves 56 extend completely through the annular valve portion 50. As shown in FIG. 2, six relief valves 56 are equally spaced about the circumference of the annular valve portion 50; however, those skilled in the art will recognize that greater or fewer relief valves 56 and alternate spacing schemes may be employed while remaining within the scope of that which is claimed. The relief valves 56 are selectively openable in response to a predetermined pressure differential between the oil passage 24 and the main oil gallery 25, shown in FIG. 1.

The operation of the oil filter 10 will be discussed in greater detail with reference to FIGS. 1 and 2. During operation of the engine 12, the oil pump 29 operates to provide oil 15, under pressure, to the main oil gallery 25 where it is subsequently introduced to the inlets 22. The oil 15 traverses the inlets 22 and biases the annular valve portion 50 of the anti-drainback valve 36 away from the closure plate 18 such that the oil 15 is allowed to flow into the canister 13. The oil 15 is forced though the filter cartridge 28 where contaminates, such as particles, are removed prior to introduction to the center portion 31 where the oil 15 is introduced to the oil passage 24 via the pipe 23 to enable reliable operation of the engine 12. Upon shut-down of the engine 12, the operation of the oil pump 29 is discontinued such that the pressure within the main oil gallery 25 is essentially zero. As a result, the oil 15 remaining within the oil passage 24 and the oil filter 10 will bias the annular valve portion 50 of the anti-drainback valve 36 against the closure plate 18 thereby blocking the backflow or reverse flow of oil 15 through the inlets 22. This is desirable since an amount of oil 15 remains within the engine 12 to provide lubrication and hydraulic control to components, such as valvetrain components, upon restart of the engine 12.

In some instances, such as when filling a newly manufactured engine with oil 15, it may be beneficial to fill the engine 12 with oil under pressure through a fill passage, not shown, in communication with the oil passage 24 to provide an amount of oil 15 to components of the engine 12 as well as providing oil 15 to aid in priming the oil pump 29. By providing pressurized oil 15 to the passage 24, in the absence of pressure within the main oil gallery 25, oil 15 is forced from the oil passage 24 to the center portion 31 of the filter cartridge 28. The oil 15 is forced through the filtering element 30 where it engages the anti-drainback valve 36. As the pressure of the oil 15 acting on the annular valve portion 50 of the anti-drainback valve 36 is increase above a predetermined level, the oil 15 will force the relief valves 56 to open thereby allowing oil 15 to flow from the canister 13, through the inlets 22, and into the main oil gallery 25. The oil 15 is subsequently introduced to the oil pump 29 where it promotes the priming of the oil pump 29. The predetermined pressure level is greater than the head pressure exerted on the anti-drainback valve 36 at engine shut-down; therefore, the anti-drainback valve 36 is still effective to maintain a quantity of oil 15 within the engine 12 to enhance operation of the engine 12 and re-start. Additionally, by providing relief valves 56 within the anti-drainback valve 36, the need to install an oil filter having no anti-drainback valve 36 to enable priming of the oil pump 29 during an engine assembly plant fill operation is obviated.

While the best modes for carrying out the invention have been described in detail, those familiar with the art to which this invention relates will recognize various alternative designs and embodiments for practicing the invention within the scope of the appended claims.

1. An oil filter assembly for an engine wherein the engine defines first and second oil passages in communication with the oil filter assembly, the oil filter assembly comprising:
an anti-drainback valve disposed within the oil filter assembly and operable to substantially restrict the flow of oil from the first oil passage when a pressure differential between the first oil passage and second oil passage is below a predetermined value; and
wherein the anti-drainback valve includes at least one relief valve operable to selectively open to allow the flow of oil from the first oil passage when the pressure differential between the first oil passage and second oil passage is greater than or equal to the predetermined value.

2. The oil filter assembly of claim 1, wherein the anti-drainback valve is formed from an elastomeric material and wherein the at least one relief valve is a molded feature formed on the anti-drainback valve.

3. The oil filter assembly of claim 1, wherein the anti-drainback valve is generally circular in shape and wherein the at least one relief valve is a slit which extends generally radially outward.

4. The oil filter assembly of claim 1, further comprising:
a generally cylindrical canister having an open end;
a closure plate operable to close the open end of the generally cylindrical canister and defining a centrally located outlet and a plurality of fluid inlets radially arranged about the outlet;
wherein the outlet is in communication with the first oil passage and the plurality of fluid inlets are in communication with the second oil passage;
a filtering element disposed within the generally cylindrical canister; and
wherein the anti-drainback valve is disposed between the filtering element and the closure plate.

5. The oil filter assembly of claim 4, wherein the anti-drainback valve is operable to selectively block the plurality of fluid inlets.

6. An anti-drainback apparatus for an oil filter assembly comprising:
an anti-drainback valve formed from an elastomeric material and operable to selectively restrict reverse flow through the oil filter assembly;
wherein the anti-drainback valve is generally frustoconical in shape; and
wherein the anti-drainback valve includes at least one relief valve to selectively open in the presence of a predetermined pressure to allow reverse flow through the oil filter assembly.

7. The anti-drainback apparatus of claim 6, wherein the at least one relief valve includes at least one slit extending generally radially outward.

8. An oil filter assembly for an engine wherein the engine defines first and second oil passages in communication with the oil filter assembly and wherein the second oil passage is in communication with an oil pump operable to selectively pressurize the second oil passage, the oil filter assembly comprising:
an anti-drainback valve disposed within the oil filter assembly and operable to substantially restrict the flow of oil from the first oil passage when the pressure differential between the first oil passage and second oil passage is below a predetermined value;
wherein the anti-drainback valve defines a plurality of relief valves operable to selectively open to allow the flow of oil from the first oil passage when the pressure differential between the first oil passage and second oil passage is greater than or equal to the predetermined value;
a generally cylindrical canister having an open end;
a closure plate operable to close the open end of the generally cylindrical canister and defining a centrally located outlet and a plurality of fluid inlets radially arranged about the outlet;
wherein the outlet is in communication with the first oil passage and the plurality of fluid inlets are in communication with the second oil passage;
a filtering element disposed within the generally cylindrical canister; and
wherein the anti-drainback valve is disposed between the filtering element and the closure plate.

9. The oil filter assembly of claim 8, wherein the anti-drainback valve is formed from an elastomeric material and wherein the at least one relief valve is a molded feature formed on the anti-drainback valve.

10. The oil filter assembly of claim 8, wherein the anti-drainback valve is generally circular in shape and wherein the at least one relief valve is generally radially outward extending slit.

11. The oil filter assembly of claim 8, wherein the anti-drainback valve is operable to selectively block the plurality of fluid inlets.
